(19) United States
(12) Patent Application Publication
(10) Pub. No.: US 2016/0302442 A1
(43) Pub. Date: Oct. 20, 2016

(54) CONFECTIONERY PRODUCT AND PROCESS FOR ITS PREPARATION

(71) Applicant: KRAFT FOODS R&D, INC., Deerfield, IL (US)

(72) Inventors: Xavier Wood, Bournville (GB); Rod Haines, St Ives (GB); Mark Mellors, St Ives (GB)

(73) Assignee: Kraft Foods R&D, Inc., Deerfield, IL (US)

(21) Appl. No.: 15/103,272

(22) PCT Filed: Jan. 6, 2015
(86) PCT No.: PCT/IB2015/050086

§ 371 Date: Jun. 9, 2016

(30) Foreign Application Priority Data
Jan. 6, 2014 (GB) 1400131.7

(51) Int. Cl. A23G 3/54; A23G 1/54; A23G 3/34

(52) U.S. Cl. CPC A23G 3/545; A23G 3/007; A23G 1/545; A23V 2002/00

(57) ABSTRACT

A confectionery composition comprising an edible shell (12) having a filling therein, said filling comprising a plurality of solid inclusions (14) and at least one liquid component (16). A method for producing the composition comprising placing a plurality of solid inclusions (14) and at least one liquid component (16) in an edible shell (12). The solid inclusions and the liquid component are then sealed within the edible shell. The solid inclusions may be discrete pieces or they may be interconnected to form a network. The edible shell may be chocolate and the liquid component may be a low viscosity sugar syrup such as runny caramel.

The present invention relates to a process for preparing a confectionery composition and compositions made thereby.

There is a continuing desire to provide new products and eating experiences for consumers. Liqueur filled chocolates are popular and provide a liquid sensation when the consumer bites through the chocolate shell and releases the filling. However, they are quite messy to consume. Caramel filled chocolates are also popular but provide a different impact on the consumer due to the high viscosity of the caramel filling.

Problems with existing products are related to complex manufacturing processes, expensive packaging, and reduced consumer acceptance.

The present invention provides a process for preparing a confectionery composition that alleviates one or more of the problems mentioned above.

In accordance with a first aspect of the present invention, there is provided a confectionery composition comprising an edible shell having a filling therein, said filling comprising a plurality of solid inclusions and at least one liquid component.

The filling exhibits a tendency to be retained within the shell when the shell is opened, for instance, by breaking the confectionery product into parts or by biting into the product.

Without wishing to be bound by theory, the inventors propose that the at least one liquid component adheres to the shell and the plurality of solid inclusions as a result of surface tension. The adhesion may be augmented by individual characteristics of the solid inclusions and/or the at least liquid component. Alternatively or concurrently, the increased adhesion may result from an interaction between the solid inclusions and the liquid component.

WO 01/78519 (Nestle S.A.) relates to a confectionery product comprising a moulded shell and a substantially planar base portion securely sealed onto the edges of the shell. The sealed assembly formed by the shell and the closure base portion delimits an inner cavity which is partially occupied with a mass formed of solid edible discrete pieces in a free-flowing state and comprises a free gas volume including interstitial spaces formed within the mass of pieces. There is no disclosure of a liquid component in addition to free-flowing discrete pieces. In fact, the purpose of WO 01/78519 cavity is to allow pieces to flow out of the shell.

A component is considered liquid in the context of the present invention if it is liquid at standard ambient temperature and pressure (SATP, 25° C. and 100 kPa).

A component is considered solid if it is solid at SATP and does not dissolve in the at least one liquid component.

It is understood that the edible shell (the shell) defines a cavity. The cavity has a volume (the cavity volume) in which the inclusions and the at least one liquid component are contained.

In one embodiment, the plurality of solid inclusions are discrete pieces i.e. they are not interconnected. In one such embodiment the discrete pieces are free-flowing so they can move independently of one another within the shell. In another embodiment the discrete pieces are packed so that they cannot move within the shell.

In one embodiment the plurality of solid inclusions are interconnected to form a network. For example, the solid inclusions can be adhered to one another. It will be understood that the solid inclusions would still be distinguishable from one another.

In accordance with the second aspect of the present invention, there is provided a method for producing a confectionery composition according to the first aspect of the present invention, comprising

providing a plurality of solid inclusions;

providing at least one liquid component;

placing the plurality of solid inclusions and the at least one liquid component in an edible shell; and

sealing the solid inclusions and the at least one liquid component within the edible shell.

The solid inclusions may be placed in the edible shell before the liquid component, after the liquid component, or at the same time as the liquid component. Typically, the solid inclusions will be placed in the edible shell before the liquid component. In this way, the liquid component can be added to fill the available volume within the shell without spillage.

In one embodiment placing the plurality of solid inclusions in the edible shell comprises placing discrete pieces in the edible shell. In one embodiment the discrete pieces are loosely packed within the shell so that they can move within the shell. Alternatively, the discrete pieced are close packed within the shell so that they cannot move.

In one such embodiment the method further comprises adhering the discrete pieces to form a network of interconnected solid inclusions within the shell. i.e. the network is formed after the solid inclusions are placed in the edible shell.

In one embodiment placing the plurality of solid inclusions in the edible shell comprises placing a network of interconnected solid inclusions in the edible shell. i.e. the network is formed before the solid inclusions are placed in the edible shell.

One method for forming a network of solid inclusions (whether before or after addition to the shell) is to employ solid inclusions having a coating which softens at elevated temperature e.g. a fat-based coating such as a chocolate coating. In this way the solid inclusions can be heated to soften the coating and then adhere the inclusions to one another on cooling.

In one embodiment, the method comprises an initial step of placing a plurality of discrete solid inclusions in a heat-resistant mould; and submitting the mould to a heat treatment to form a network of interconnected solid inclusions.

The heat treatment should only melt the surface of the plurality solid inclusions.

It is an advantage of using a pre-formed network that the network formation can occur under conditions that are undesirable for the shell. For instance, the formation may be mediated by a heat treatment at a temperature that is higher than the melting temperature of the shell. The network formation may be mediated by a cooling phase.

It is a further advantage of using a pre-formed network that it is easier to perform quality assurance procedures on the pre-formed network.

In one embodiment, the method comprises a step of cooling the interconnected solid inclusions.

In one particular embodiment, the mould corresponds in size and shape to the volume of the edible shell. A network formed in a mould of corresponding volume can be placed into the edible shell without difficulty.

In one embodiment, the edible shell has a partially molten inner surface to cause the inclusions to be embedded therein.

The control of the melting conditions ensures that the surface of the solid inclusions melts only just enough to fuse adjacent solid inclusions together, without completely melting the solid inclusions or any coating away.

Liquid Component(s)

The viscosity of the at least one liquid component will affect the sensation perceived by the consumer; the lower the viscosity the more liquid the sensation. The viscosity of the liquid filling should be greater than water but less than that of a conventional soft caramel. Viscosity can be described in a number of ways.

The viscosity of common foodstuffs is known from the literature. For example, the following values were obtained from a Viscosity Chart on the BASCO website: http://www.bascousa.com/images/advisors/407%20condensed.pdf.

| | Absolute | Temperature | | Absolute | Temperature |
|---|---|---|---|---|---|
| | viscosity (cP) | (° F./° C.) | | viscosity (cP) | (° F./° C.) |
| Butter fat | 42 | 110/43 | Corn syrup | 12000 | 130/54 |
| Butter fat | 20 | 150/66 | Gelatin, | 1190 | 110/43 |
| | | | 37% solids | | |
| Cottage | 30000 | 65/18 | Fruit juice | 55-75 | 65/18 |
| cheese | | | | | |
| Cocoa butter | 50 | 140/60 | Honey | 1500 | 100/38 |
| Cocoa butter | 0.5 | 210/99 | Mashed | 20000 | 100/38 |
| | | | potato | | |
| Condensed | 40-80 | 100-120/38-49 | Mayonnaise | 20000 | 70/21 |
| milk | | | | | |
| Condensed | 2160 | 70/21 | Molasses | 1400-13000 | 100/38 |
| milk, 75% | | | | | |
| solids | | | | | |
| Cream, 45% | 48 | 60/16 | Orange juice | 630 | 70/21 |
| fat | | | concentrate | | |
| | | | (30 brix) | | |
| Milk | 2.0 | 65/18 | Orange juice | 91 | 175/79 |
| | | | concentrate | | |
| | | | (30 brix) | | |
| Yoghurt | 152 | 105/41 | Sorbitol | 200 | 70/21 |
| Caramel | 400 | 140/60 | Toffee | 87000 | 100/38 |
| Chocolate | 17000 | 120/49 | Tomato | 195 | 65/18 |
| | | | paste, 30% | | |
| Chocolate | 280 | 120/49 | Olive oil | 40 | 100/38 |
| milk | | | | | |
| Coffee, 30- | 10-100 | 70/21 | Palm oil | 43 | 100/38 |
| 40% liquor | | | | | |

The at least one liquid component may be a Newtonian liquid or a non-Newtonian liquid. The viscosity of Newtonian liquids is independent of the rate of shear (mixing) but changes with temperature (e.g. water, ethanol, glycerol). Non-Newtonian liquids (e.g. chocolate) are affected by the presence of solids in suspension so their viscosity depends on temperature and the rate of shear.

Viscosity can be measured using a rotational viscometer (or rheometer) such as the Bohlin, Brookfield or Haake viscometer. In one embodiment viscosity is measured using a Bohlin CV050 rheometer. In another embodiment viscosity is measured using a Brookfield RVDVIII Ultra rheometer

In one embodiment the at least one liquid component is a Newtonian liquid and has a viscosity measured at 25° C. of no more than 20, 15, 10, 5, 3, 2, 1.0, 0.50, 0.10, 0.05, 0.01 or 0.001 Pa·s.

In one embodiment the at least one liquid component is a Newtonian liquid and has a viscosity measured at 25° C. of at least 0.001, 0.01, 0.05, 0.1, 0.50, 1.0, 2, 3, 4 or 5 Pa·s. In a particular embodiment the liquid filling has a viscosity at 25° C. of from 0.05 to 0.07. For comparison, water has a viscosity at 25° C. of approximately 8.94×10⁻⁴ Pa·s.

The viscosity of the liquid filling can be measured using a Bohlin CV050 rotational rheometer at a constant temperature of 25° C. The effect of shear can be determined by increasing the shear stress from 1 to 10 Pa.

In one series of embodiments the liquid filling has a viscosity measured at 10 s⁻¹ of less than 100, 85 or 60 Pa·s at 25° C.; of less than 50, 35 or 10 Pa·s at 35° C.; and/or less than 25, 15, 5 or 1 Pa·s at 45° C.

In one series of embodiments the at least one liquid component is a non-Newtonian liquid and has a viscosity measured at 30° C. of less than 15 Pa·s at 1 s⁻¹, less than 13 Pa·s at 10 s⁻¹ and/or less than 7 Pa·s at 100 s⁻¹.

The viscosity of the liquid filling can be described with reference to the Power Law (or Ostwald) Model. This fits a typical viscosity vs. shear rate curve and takes the form of:

y=Kxⁿ⁻¹

Where y=viscosity, x=shear rate, K=consistency coefficient (viscosity at a shear rate of 1 s⁻¹) and n=power law index (or flow law index).

n is a measure of how Newtonian the liquid is. A Newtonian liquid has n=1, such that y=K i.e. no change in viscosity with shear rate. For a shear thinning liquid n is greater than 0 but less than 1. For a shear thickening liquid n is greater than 1.

In one embodiment the liquid filling has a power law index (n) of from 0.8 to 1.2 or from 0.9 to 1.1. The power law index (n) can be calculated using the following protocol (provided by Brookfield):

Instrument: Brookfield RVDVIII Ultra rheometer fitted with a Small Sample adaptor and spindle/chamber SC4-15/7R. Temperature: 25° C. RPM down-ramp: 50, 40, 30, 20, 10, 5, 2.5, 1.5. 1 minute hold at each speed before recording viscosity value. Plot Viscosity vs. Shear rate to determine n.

The pour point of a liquid is the lowest temperature at which it will flow before it becomes semi-solid and loses its flow characteristics. In one embodiment the at least one liquid component has a pour point of less than 25, 20, 15, 10, 5 or 3° C.

It is an advantage of providing liquids in these viscosity ranges that they provide a liquid appearance and mouth feel to the consumer. The inventors found that surprisingly, the provision of such liquids in a network of solid inclusions results in a product that does not show a tendency to drip when opened.

In one embodiment, the at least one liquid component constitutes at least 1%, 5%, 10%, 15%, 20%, 25%, 30%, 35% or 40%, of the volume of the cavity.

In one embodiment, the at least one liquid component constitutes less than 40%, 35%, 30%, 25%, 20%, 15%, 10%, or 5% of the volume of the cavity.

In one embodiment, the at least one liquid component constitutes from 1 to 50%, from 5 to 40%, from 5 to 35%, from 5 to 30%, from 5 to 25%, from 10 to 40%, from 10 to 35%, from 10 to 30%, from 10 to 25%, from 15 to 40%, from 15 to 35%, from 15 to 30%, from 15 to 25%, or from 17 to 23% of the volume of the cavity.

The at least one liquid component can be any liquid confectionery material such as an aqueous solution, a water-in-oil emulsion or an oil-in-water emulsion. It will be understood that the at least one liquid component must be edible.

In one embodiment, the at least one liquid component is selected from the group comprising fruit juice; vegetable juice; fruit puree (coulis); vegetable puree; fruit sauce;vegetable sauce; honey; liqueur, fondant, alcohol (ethanol), caramel; sugar syrup; polyol syrup; hydrogenated starch hydrolysates syrup; emulsions; vegetable oil; glycerin; propylene glycol; ethanol; dairy-based liquids such as milk, cream, etc.; fondant; an isomalt-comprising solution; and combinations thereof. In one such embodiment the liquid filling is selected from the group consisting of fruit juice; vegetable juice; fruit puree; fruit pulp; vegetable pulp; vegetable puree; fruit sauce; vegetable sauce; sugar syrup; polyol syrup; glycerin; caramel and combinations thereof.

In one embodiment the at least one liquid component is a flavoured sugar or sugar substitute syrup. In one such embodiment the syrup comprises bulk sweetener (e.g. sucrose or polyol), water and flavouring. In one embodiment the sugar or sugar substitute syrup has a solids content of no more than 75%, no more than 60%, no more than 50 or no more than 40%. A reduction in solids content is expected to reduce the viscosity of the liquid filling and thereby provide a greater contrast with the solid inclusions. In one embodiment the at least one liquid filling is selected from one or more of almond, apple, apricot, banana, basil, butterscotch, blueberry, caramel, cardamom, cherry, chocolate, hazelnut, kiwi, lime, mango, melon, orange, peach, raspberry, strawberry, vanilla syrup. Suitable syrups are commercially available and include those sold under the Monin® brand.

Sugars include sucrose, glucose, fructose, lactose and maltose and any combination thereof). Sugar substitutes include sugar alcohols such as sorbitol, xylitol, mannitol, lactitol and isomalt.

The solid inclusions and/or the at least one liquid component also may include any components known in the art for incorporation with centre-fill compositions. In some embodiments, the solid inclusions and/or the at least one liquid component may contain traditional ingredients well known in the confectionery arts, such as flavouring agents, colourings, sweetening agents, and the like, and mixtures thereof. In addition to confectionery additives, the solid inclusions and/or the at least one liquid component may also contain pharmaceutical additives such as medicaments, breath fresheners, vitamins, minerals, caffeine, fruit juices, and the like, and mixtures thereof.

A low water activity will assist in rendering the at least one liquid component microbiologically stable. In one embodiment the liquid component has a water activity measured at 25° C. of 1 or less than 1.0, 0.95, 0.9, 0.8, 0.7, 0.65 or 0.60.

Solid Inclusions

In one embodiment, the solid inclusions are close packed within the shell so that they cannot move over one another. The close packing is dictated by the size of the inclusions and the size of the cavity. For instance, a plurality of spherical solid inclusions of the same size will be limited to 74% packing density if they can be arranged in a hexagonal close packing structure. If the plurality of spherical solid inclusions is confined to a simple cubic packing structure, the packing density is limited to 52%. Simulations have shown that spheres randomly filled into a volume reach packing efficiencies of between 60% and 68%. It is thus understood that, other variations of the particle properties aside, the volume of spherical solid inclusions in a close packed shell can be expected to be in the region of between 52% and 74% of the volume of the cavity in a first approximation. The volume of solid inclusions in the cavity can be lower if efficient packing densities are not achieved and the volume of solid inclusions may be lower or higher if the solid inclusions are not spherical.

FIG. 1 shows a plurality of coated puffed rice balls 10 which are an example of approximately spherical inclusions. The balls 10 do not have perfect close packing; the arrangement is not exactly regular. However, it can be seen that the packing does approach hexagaonal close-packed in some regions. For example, each of balls 10′, 10″ and 10′″ is surrounded by 6 other balls.

When the solid inclusions are close packed, the interstitial volume available for the at least one liquid component can be deduced from the packing efficiency of the solid inclusions.

In one series of embodiments, the solid inclusions constitute at least 40%, 50%, 60%, 70%, or 80% of the volume of the cavity. In one series of embodiments, the solid inclusions constitute less than 90%, 80%, 70%, 60%, or 50% of the volume of the cavity. In one particular series of embodiments, the solid inclusions constitute from 40 to 74%, from 50 to 68%, or from 55 to 64% of the volume of the cavity.

The following statements apply to at least one solid inclusion and/or the average properties of all of the solid inclusions in the shell.

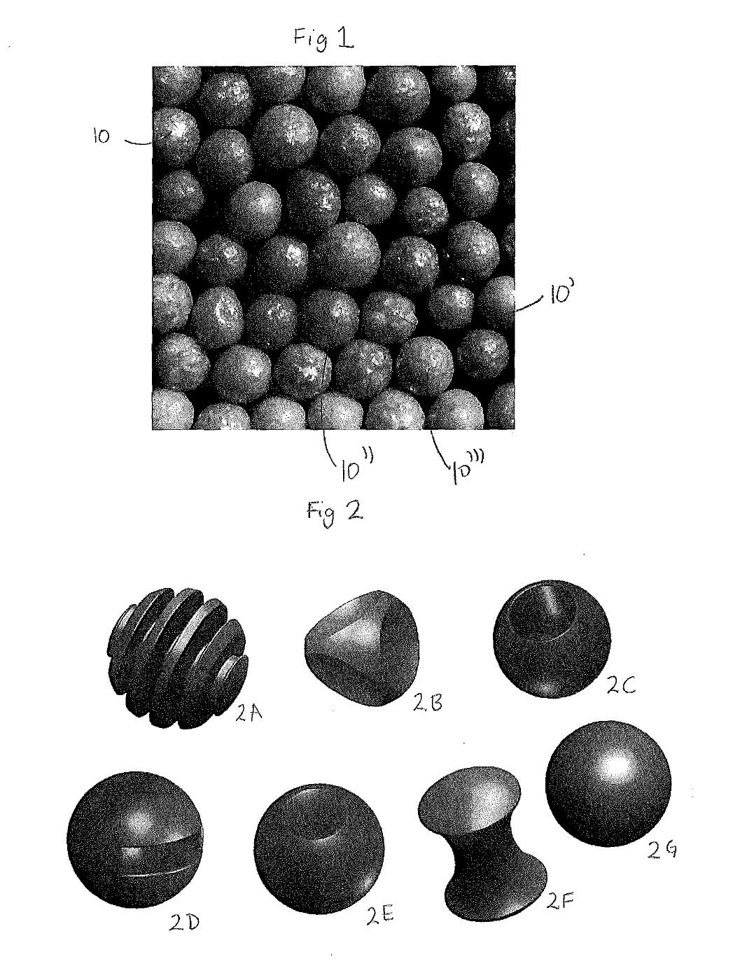

In one embodiment the solid inclusions are generally spherical, ovoid, cubic, cuboid, star shaped, lozenge shaped or heart shaped. In a particular embodiment all of the solid inclusions are spherical. A range of suitable shapes for use as solid inclusions are shown in FIG. 2. The shapes are either a sphere (FIG. 2G) or based on a sphere but with cut-outs (FIG. 2A to 2F). The use of cut-outs is thought to be useful for encouraging the liquid component to adhere thereto. In one embodiment the solid inclusions have cut-outs.

The solid inclusions may be hemi-spherical or elongate. The solid inclusions may comprise a concave portion.

In one embodiment the solid inclusions are in the form of shells such as hemi-spherical shells. Hemi-spherical shells can be prepared by passing material (e.g. chocolate) through dimpled rollers.

In one embodiment, the solid inclusions are irregularly shaped.

It is understood that spheres have the lowest surface area to volume ratio compared to other three dimensional shapes. It is an advantage of non-spherical inclusions that they provide a larger surface area per unit volume, which increases the surface available for adsorbing/absorbing the at least one liquid component. Conversely, it is an advantage of spherical inclusions that their packing density and interstitial volumes approximate mathematically defined models. This facilitates the production of reproducible confectionery compositions.

The solid inclusions may be of essentially the same size and shape, or of varying size and shape. The size of irregularly shaped inclusions may be defined as the largest diameter extending through the centre point of the inclusion. The size of spherical inclusions may be defined as the diameter of the inclusion. Where inclusions vary in size, the largest inclusion may be at least 2× the size of the smallest inclusion, at least 3× the size of the smallest inclusion, at least 4× the size of the smallest inclusion, at least 5× the size of the smallest inclusion, or at least 6× the size of the smallest inclusion.

The greater the diameter of each inclusion, the fewer can be held within the shell. It is an advantage that a large number of inclusions may be used to provide a complex mouth feel. It is an advantage of using smaller inclusions that these are compatible with a wide range of shells of different shapes and formats.

In one series of embodiments in which spherical inclusions of the same size are provided in the shell cavity, the volume of the solid inclusions constitutes less than 74%, 68%, 64%, 60%, or 50% of the volume of the cavity. In one embodiment, the spherical solid inclusions constitute at least 30%, 40%, 50%, 60%, or 70% of the volume of the cavity. In one particular embodiment, the spherical solid inclusions constitute from 30% to 70%, from 35% to 60%, from 40% to 55%, or from 45% to 50%, of the volume of the cavity.

When the confectionery shell is close packed with solid inclusions of essentially the same size, the interstitial volume the inclusions is determined by the size of the individual inclusions. It is an advantage of mixing inclusions of different size that the available interstitial volume between the solid inclusions (or, respectively, the ratio of solid volume to cavity volume) can be influenced.

In one embodiment, the solid inclusions do not readily absorb the at least one liquid component. In one embodiment, the solid inclusions do not soften when in contact with the at least one liquid component.

In one series of embodiments the solid inclusion(s) has/have a diameter of at least 0.5, 1, 2, 3, 4, 5, 6, 7, 8, 9, 10, 11, 12, 13, 14 or 15 mm. In one series of embodiments at least one solid inclusion has a diameter of no more than 40, 30, 20, 15, 12, 10, 9, 8, 7, 6, or 5 mm. In a particular embodiment at least one solid inclusion has a diameter of from 4 to 8 mm or from 5 to 7 mm.

In one embodiment, the solid inclusion(s) is/are a capsule(s) having a cavity therein. In one embodiment, the capsule(s) has/have an inner diameter (the size of the cavity within the solid inclusion) of at least 2, 2.5, 3, 3.5, 4, 4.5, 5, 5.5, 6, 6.5, 7 or 7.5 mm. In one embodiment the capsule(s) has/have an inner diameter of less than 25, 10, 15, 10 or 5 mm. In a particular embodiment the capsule(s) has/have an inner diameter of from 2 to 5 mm or from 2.5 to 4 mm.

In one embodiment the capsule(s) has/have a wall thickness (difference between inner and outer diameters) of at least 0.5, 0.75, 1, 1.25, 1.5, 1.75, 2, 2.5, 3 or 3.5 mm. In one embodiment the capsule(s) has/have a wall thickness (difference between inner and outer diameters) of less than 20, 15, 10, 5, 4.5, 4, 3, 3.5, 3, 2.5 2, 1.75, 1.5, 1.25, or 1 mm.

In one embodiment the capsule(s) wall has/have uniform thickness no matter where it is measured. By uniform, we mean that the wall thickness of the capsule varies by no more than 15, 10, or 5% as compared to the average wall thickness of that capsule.

In one embodiment, the capsule has a liquid filling therein. The liquid capsule filling may be selected from the group of materials suitable as the at least one liquid component (described above).

In one embodiment, the edible shell comprises a mixture of solid inclusions. A mixture of solid inclusions may consist of spheres of the same material having different sizes. The solid inclusions may be selected from essentially two sizes.

It is understood that the size of an inclusion composition of two differently sized inclusion types may be described by a binomial distribution. Accordingly, the size of an inclusion composition of a plurality of differently sized inclusion types may be described by a multinomial distribution. An inclusion composition may consist of spheres having the same size but different material composition. An inclusion composition may consist of white chocolate and dark chocolate inclusions. The solid inclusions may vary in colour, texture, or flavour.

The solid inclusions should not absorb the liquid component (soak it up) since this would make them soggy. The solid inclusions might require a moisture barrier to prevent them absorbing the liquid component.

In one embodiment the solids inclusions are chocolate pieces, nuts or seeds (which do not require a moisture barrier).

In one embodiment the solid inclusions are selected from the group of marshmallow, puffed wheat, cookie pieces, biscuit pieces, cereals (especially expanded or puffed cereals), raisins, popcorn, dried fruit pieces, or a combination of these. These inclusions may require a moisture barrier to prevent sogginess.

In one embodiment, the solid inclusions may comprise a centre portion and a coating. The coating may be provided to prevent contact between the at least one liquid component and the centre portion of the solid inclusion. The coating may be provided to assist formation of the interconnected network.

The coating may be a solid at SATP but melt more readily than the centre portion. The coating can then be melted to fuse the solid inclusions together. In one embodiment, the coating is a glazing.

The formation of a network can be promoted by providing a coating having a lower melting temperature than the centre portion. The heat treatment can be controlled such that only the surface of the coating or an outer portion of the coating melts. During a subsequent cooling phase the adjacent surfaces can fuse together to form the network. The cooling temperature during the cooling phase may be room temperature or below room temperature.

The coating may further assist in providing a defined geometric shape of the solid inclusions, despite using irregularly shaped centre portion. For instance, pieces of nut or hard caramel may be provided in a coating with a round outer cross-section.

Different inclusion compositions may have a different capacity to retain the at least one liquid component.

It is an advantage that different inclusion compositions can be provided because this allows providing different mouth feel and visual appeal of the opened shell. It is a further advantage that the use of different inclusion compositions provides a degree of control over the retention behaviour so that it can be matched to the adhesive properties of the at least one liquid component.

The shell may comprise a gas such as air, CO₂, or N₂. The gas will be located in the interstitial volume between the solid inclusions and the at least one liquid component.

It is an advantage of providing an interconnected or partially interconnected network that a stable distribution of solid inclusions can be achieved without having to fill the shell entirely.

Upon opening the shell, it has been observed that the at least one liquid component on the solid inclusions creates a bubbly appearance. This may increase the consumer perception of liquidity and enjoyment of a luxury food item.

The cooling step facilitates the control of the fusing together of the plurality of solid inclusions.

In one embodiment the shell is a sugar-based confectionery shell or a fat-based confectionery shell. In one embodiment, the fat-based confectionery shell is a chocolate shell.

Edible Shell Properties

The dimensions (size and shape) of the edible shell can vary from small bite-size pieces to large tablets. The present invention is particularly beneficial for larger products where a liquid filling would otherwise be very messy to consume.

In one embodiment the edible shell has a length of at least 3, 4, 5, 6, 8, 10, 12, 15, 20 or 25 cm. In one embodiment the edible shell has a length of less than 30, 25, 20, 15 or 10 cm.

In one embodiment the edible shell has a thickness of at least 2, 3, 4, 5, 6, 7, 8, 9 or 10 mm. In one embodiment the edible shell has a thickness of less than 20, 15, 12, 8, 6, or 4 mm.

In one embodiment the edible shell has at least 2, 3, 4, 5, 6, 7, 8, 9, 10, 11, 12, 13, 14, 15, 20, 25, 30, 40, 50, 60, 70 or 80 inclusions therein. In one embodiment, the edible shell has fewer than 200, 150, 100, 75, 65, 55, 45, 35, 25, 15 or 10 inclusions therein.

In one embodiment the edible shell is elongate with a uniform cross-section e.g. a chocolate bar. In one such embodiment the cross-section is square or rectangular (such that the shell is cuboid). In another embodiment the cross-section is trapezoidal.

In one embodiment the edible shell has a moisture barrier on its inner surface. This can be useful if the liquid component would otherwise soak into the shell.

In one embodiment, all of the solid inclusions are identical e.g. they have the same size, shape, liquid filling etc. In another embodiment the edible shell has a variety of inclusions therein.

In one embodiment, the shell contains at least one line of weakness.

It is an advantage that the at least on line of weakness facilitates the breaking off of pre-defined portion sizes. This allows predetermining portion sizes that contain a minimum number of solid inclusions.

In one embodiment the shell has a smaller cross-section at places corresponding to the at least one line of weakness.

It is believed to be an advantage of the smaller cross-section that it impedes solid inclusions from falling out of a broken off portion.

The term ‘chocolate’ in the context of the present invention is not restricted by the various definitions of chocolate provided by government and regulatory bodies. A ‘chocolate’ may be a dark chocolate, a milk chocolate or a white chocolate.

Chocolate comprises at least one fat. The fat may be cocoa butter, butterfat, a cocoa butter equivalent (CBE), a cocoa butter substitute (CBS), a vegetable fat that is liquid at standard ambient temperature and pressure (SATP, 25° C. and 100 kPa) or any combination of the above. In a particular embodiment, the chocolate comprises cocoa butter.

CBEs are defined in Directive 2000/36/EC. Suitable CBEs include illipe, Borneo tallow, tengkawang, palm oil, sal, shea, kokum gurgi and mango kernel. CBE's are usually used in combination with cocoa butter. In one embodiment, the chocolate comprises no more than 5 wt % CBE's.

The chocolate may comprise a cocoa butter substitute (CBS) (sometimes known as a cocoa butter replacer, CBR) in place of some or all of the cocoa butter. Such chocolate materials are sometimes known as compound chocolate. Suitable CBS's include CBS laurics and CBS non-laurics. CBS laurics are short-chain fatty acid glycerides. Their physical properties vary but they all have triglyceride configurations that make them compatible with cocoa butter. Suitable CBS's include those based on palm kernel oil and coconut oil. CBS non-laurics consist of fractions obtained from hydrogenated oils.

The oils are selectively hydrogenated with the formation of trans acids, which increases the solid phase of the fat. Suitable sources for CBS nonlaurics include soya, cottonseed, peanut, rapeseed and corn (maize) oil.

In one embodiment the chocolate comprises fat (e.g. cocoa butter or a cocoa butter equivalent or cocoa butter substitute), a bulk sweetener (e.g. a sugar or sugar substitute) and non-fat cocoa solids (e.g. from cocoa liquor or cocoa mass).

Embodiments of the invention will now be described by way of example only in which:

FIG. 1 shows packing of solid inclusions;

FIG. 2 shows a range of shapes for solid inclusions;

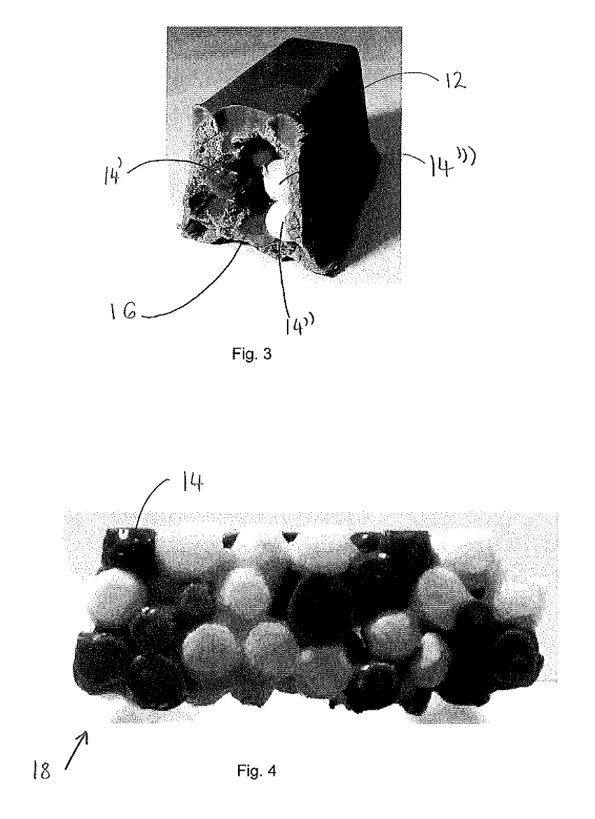

FIG. 3 shows part of a confectionery composition in accordance with an embodiment of the invention; and

FIG. 4 shows a plurality of solid inclusions for use in an embodiment of the invention.

Referring to FIG. 3, there is shown part of a chocolate shell 12. The shell is elongate with a trapezoidal cross-section. The shell 12 has been bitten into such that three spherical solid inclusions 14 are visible. The inclusions 14 are puffed rice balls having identical dimensions. One of the rice balls 14′ has a milk chocolate coating and two of the balls 14″, 14′″ have a white chocolate coating. The shell 12 also contains a thin (low viscosity) caramel 16. The caramel 16 does not drip; it adheres to the shell 12 and the inclusions 14.

Referring to FIG. 4 there is shown a network 18 of interconnected solid inclusions 14. As described in FIG. 3, the inclusions are puffed rice balls having either a white or a milk chocolate coating. The rice balls were heated in a mould to cause the coating to partially melt and thereby fuse the rice balls into a network.

Methodology

The viscosity of a liquid component was determined using a Bohlin CV050 rheometer at constant temperature (25° C.) with shear stress being increased from 1 to 10 Pa. The following example shows the measurement of the viscosity of a commercially available caramel syrup (Le sirop de Monin® caramel, available from Monin (Bourges, France)).

The syrup has the following ingredients: sugar, water, flavouring, natural plant extracts, colouring agent: E150a, acidifying agent: citric acid.

Viscosity @ 25° C. (Pa · s)

| Shear Rate (1/s) | Shear Stress (Pa) | Viscosity (Pa · s) |
|---|---|---|
| 16.3 | 1 | 0.0612 |
| 20.9 | 1.29 | 0.0617 |
| 26.7 | 1.67 | 0.0624 |
| 34.3 | 2.15 | 0.0628 |
| 44.1 | 2.78 | 0.0631 |
| 56.6 | 3.59 | 0.0634 |
| 72.9 | 4.64 | 0.0636 |
| 94.2 | 5.99 | 0.0636 |
| 121.5 | 7.74 | 0.0638 |
| 156.5 | 10 | 0.0639 |

It can be seen that the viscosity of the caramel changes only slightly as the shear rate increases from 16.3 to 156.5 s⁻¹; it is around 0.06 Pa·s under the conditions of measurement.

### EXAMPLE 1

A chocolate bar consisting of a chocolate shell having filling, the filling comprising interconnected chocolate coated rice balls and at least 15% low viscosity caramel.

Chocolate coated rice balls (diameter 6 mm) were heated in a silicone mould at 40° C. to 50° C. for 10 to 15 minutes so that the chocolate glaze partially melted and fused the rice balls to form an interconnected network, as shown in FIG. 4.

The network of glazed rice balls was then transferred to a preformed chocolate shell having a trapezoidal cross-section. The shell was 2 mm thick. A runny caramel (as described above and having a water activity of 0.7) was then added and the shell backed off. The final products contained from 15% to 25% (v/v) of liquid caramel.

Portions could be bitten from the product without caramel dripping from the open network. A representation of the confectionery composition of Example 1 is shown in FIG. 3.

1. A confectionery composition comprising an edible shell having a filling therein, said filling comprising a plurality of solid inclusions and at least one liquid component.

2. The composition of claim 1, wherein the plurality of solid inclusions are discrete pieces.

3. The composition of claim 2, wherein the discete pieces are closed packed within the edible shell so that they cannot move over one another.

4. The composition of claim 1, wherein the plurality of solid inclusions are interconnected to form a network.

5. A method for producing a confectionery composition according to claim 1 comprising
providing a plurality of solid inclusions;
providing at least one liquid component;
placing the plurality of solid inclusions and the at least one liquid component in an edible shell; and
sealing the solid inclusions and the at least one liquid component within the edible shell.

6. The method of claim 5, wherein placing the plurality of solid inclusions in the edible shell comprises placing discrete pieces in the edible shell.

7. The method of claim 6, further comprising adhering the discrete pieces to one another to form a network of interconnected solid inclusions within the shell.

8. The method of claim 5, wherein placing the plurality of solid inclusions in the edible shell comprises placing a network of interconnected solid inclusions in the edible shell.

9. The method of claim 8, comprising an initial step of
placing a plurality of discrete solid inclusions in a heat-resistant mould; and
submitting the mould to a heat treatment to form a network of interconnected solid inclusions.

10. The method of claim 5 wherein the solid inclusions having a coating which softens at elevated temperature.

11. The method of claim 5, wherein the at least one liquid component is caramel.

12. The method of claim 5, wherein the at least one liquid component has a viscosity measured at 25° C. of no more than 1 Pa·s.

13. The method of claim 5, wherein the shell defines a cavity therein and the at least one liquid component constitutes from 10 to 40% of the volume of the cavity.

14. The method of claim 5, wherein the shell defines a cavity therein and the plurality of solid inclusions constitute from 40 to 60% of the volume of the cavity.

15. The method of claim 5 wherein the plurality of solid inclusions are spherical.

16. The method of claim 5 wherein the solid inclusions comprise chocolate.

17. The method of claim 5 wherein the edible shell is a chocolate shell.
